(19) United States
(12) Patent Application Publication
(10) Pub. No.: US 2003/0047127 A1
(43) Pub. Date: Mar. 13, 2003

(54) Remote locator device

(76) Inventor: James R. Jordan, Baker, NV (US)

Correspondence Address: Christopher J. Whewell, Western Patent Group, 6020 Tonkowa Trail, Georgetown, TX, 78628, US

(21) Appl. No.: 09/947,598

(22) Filed: Sep. 7, 2001

(51) Int. Cl. G08B 5/02

(52) U.S. Cl. 116/209; 116/200

(57) ABSTRACT

Provided herein are articles by which the visibility of remote control units used in conjunction with television sets, stereos, video cassette recorders and the like is increased, so as to reduce or totally eliminate the propensity for such remote units to become lost within the environment in which they are used, such as in a den or living room. Articles according to the invention may be affixed to a wide variety of remote control units by virtue of their construction, and are thus universal in application.

The present invention is based in part on the disclosure contained in Disclosure Document 464559, filed on Nov. 3, 1999.

### TECHNICAL FIELD

This invention relates to an article useful in assisting the user of a remote control unit or other similar electronic unit in locating such units in areas in which they are utilized, for cases when the units have become obscured from view, for various reasons.

### BACKGROUND

Remote control units useful for controlling various functional characteristics of electronic devices have been in widespread use in the United States for decades. A remote control unit typically comprises a hand-held box which includes various circuitries and the like which render it capable of communicating with the electronic device which is desired to be controlled, via rf, infrared, sound, or other forms of energy. Electronic devices controllable by such hand-held remote control means include television sets, video cassette recorders, stereos, etc.

Since remote control units have been designed to be hand-held and easy to use, one inherent drawback of which they are possessed is that they may become lost in a room or house in which they are used. Remote control units may easily fall into a crack in a sofa or chair, or may be placed upon a shelf in a position invisible from persons in the room. If a user of a remote control unit goes away for a length of time and then returns to the room and looks for the mote control unit, often, the remote control unit is difficult to see and time must be expended in locating the remote control unit. this is especially cumbersome for persons with vision restrictions, or handicapped persons.

Workers in the prior art have recognized that problems with locating remote control devices exist and have attempted to provide contrivances by which remote control units do not get lost.

U.S. Pat. No. 4,770,114 discloses a finder means for a T.V. remote control box comprising an elongated tail and means for connecting the tail to the remote control box wherein the tail is brightly colored and generally contrasting with the color of newspapers. The tail has at least one bell attached thereto, and at least one aperture therein for hanging up the tail, and the means for connecting comprising an elastic band adapted to surround the T.V. remote control box.

U.S. Pat. No. 5,195,634 discloses a holder which makes it more difficult to misplace remote control units. The holder includes an enclosure having a compartment for holding a remote control unit therein when the remote control unit is idle and a cover which may be opened so that the remote control unit may be removed from the compartment for use and may be returned to the compartment after use. An attaching mechanism connects the remote control unit to the enclosure so that the remote control unit cannot be separated from its holder. Since the enclosure is larger than the remote control unit, it is more difficult to misplace the enclosure containing the remote control unit than it is to misplace the remote control unit alone.

U.S. Pat. No. 5,316,249 teaches a stand for holding an electronic remote control unit having a horizontal bottom surface, a contiguous vertical end surface extending upwardly from one end of the bottom surface, and a contiguous rectangular top surface extending outwardly from the upper end of the vertical surface spaced directly above the horizontal bottom surface for releasably supporting an electronic remote control unit thereon. An extendible coiled tether cord is secured at one end to the stand and its free end is connected to the remote control unit whereby the remote control unit may be removed from a position supported on the stand but is prevented from complete separation from the stand. Fabric hook and loop fasteners are provided on the free end of the tether and top surface of the stand. In a preferred embodiment, the stand is provided with suction cups to anchor the stand on the flat surface which facilitate disengagement of the hook and loop fasteners and allows the remote control unit to be easily removed from the stand with one hand. Since the remote control unit is tethered to the stand it cannot be completely separated therefrom and will not become lost or misplaced, and because the stand can be anchored by suction cups, the likelihood of the entire stand being removed from the location in which the remote control unit is used is reduced.

However, of all the prior art, none has thus far provided a device useful in increasing the awareness of the user of a remote control unit as to the whereabouts of the unit which is effective, universally applicable to a wide variety of remote control units, and which is priced within a range so as to be affordable by the general population. The present invention provides such devices.

### BRIEF DESCRIPTION OF THE DRAWINGS

FIG. 1 is a side perspective view of an article according to the invention;

FIG. 2 is a side perspective view of an article according to the invention; and

FIG. 3 is a perspective view of an article according to the invention affixed to a remote control unit.

### SUMMARY OF THE INVENTION

The present invention comprises an article useful for increasing the visibility of a remote control unit. An article according to the invention comprises: an affixing band means which has a length dimension. The affixing band means is adapted to be snugly adhered to the outer periphery of a remote control unit. There are a plurality of streamers, each having a length dimension, which streamers are disposed along the length dimension of the affixing band so that the length dimension of said streamers is substantially perpendicular to the length dimension of said affixing band means.

### DETAILED DESCRIPTION

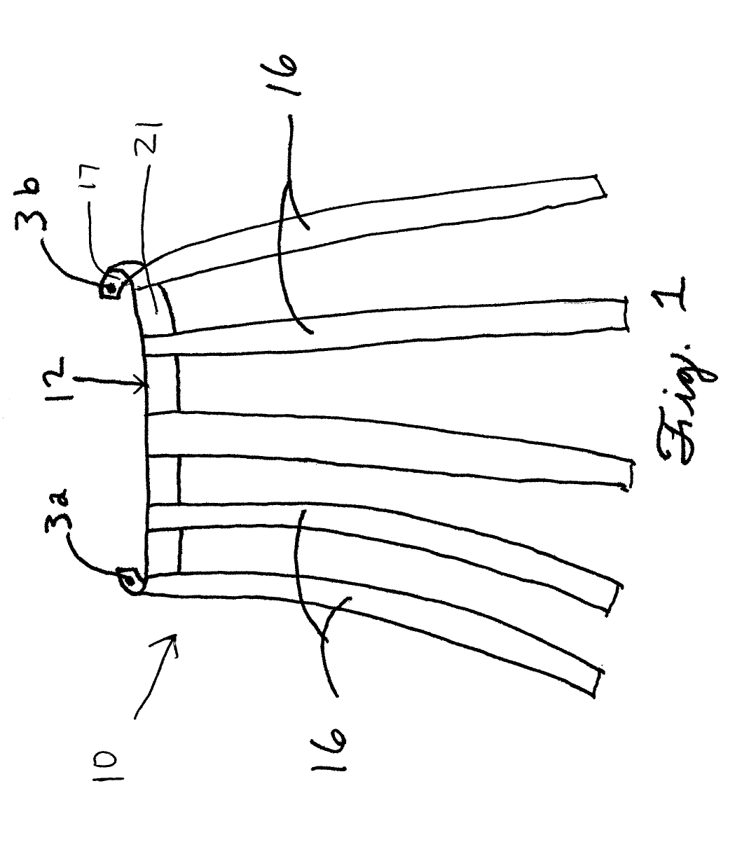

An article according to the invention comprises an affixing band means and a plurality of streamers attached to the affixing band means. Referring to the drawings and initially to FIG. 1 there is shown an article according to one form of the invention. In FIG. 1, 12 represents the affixing band means, 16 represents the streamers, and 3a and 3b each respectively represent complementary counterparts of a closure means, which are disposed in the proximity of the end portions of the affixing band means, so that the ends of the affixing band means may be connected to one another so as to form a closed loop. The affixing band means has a first face portion 17 which is intended to contact the remote control unit to which it is ultimately affixed, and a second face portion 21.

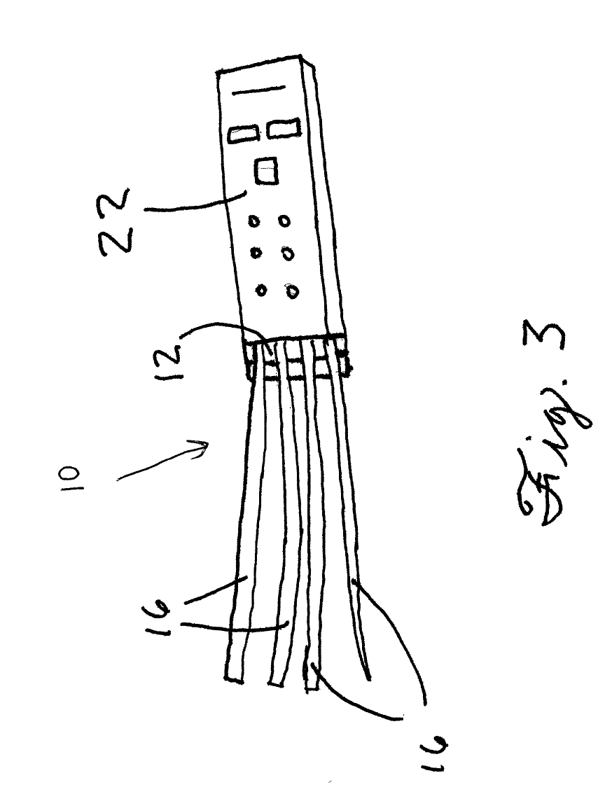

The affixing band means 12 is in its simplest form a strip of fabric or polymeric material such as a band of plastic or elastic material. The length of the affixing band means 12 is selected so that when the first end portion and second end portion of the affixing band are attached to one another, such as by the closure means, the affixing band is dimensioned to fit snugly about the outer periphery of a remote control unit, as later shown in FIG. 3. The affixing band means may be comprised of various materials, including without limitation, elastic or other elastomeric fabrics, string, wire, rope, metallic tape, plastic tape, cloth tape, metallic foil, as all of these materials, without limitation, are functionally-equivalent within the context of this specification and the appended claims. The only requirement of an affixing band means according to the invention is that it must be attachable to the outer periphery of a remote control unit, and it must be capable of having at least one streamer affixed to it. The closure means may be any conventional clasping or closure means known in the art, including without limitation, buttons, snaps, hook and loop fasteners such as VELCRO®, hook and eye fasteners, etc.

An affixing band means according to an alternate form of the invention may also comprise a closed loop of elastomeric material, such as elastic, with no closure means are provided, since in such embodiment the affixing band does not comprise end portions. In such embodiment, the inner diameter of the loop of elastomeric material is selected to that the affixing band means may be slightly stretched, placed over the outer periphery of a remote control unit, and then the stretching is relaxed, to provide a snug fit of the affixing band about the outer periphery of the remote control unit.

In another alternate form of the invention, the affixing band means is provided with an adhesive substance on its surface which is intended to contact the remote control unit. Suitable adhesive substances are well-known in the art of adhesives technology, with the only proviso being that the adhesive selected must be capable of securing the affixing band means to the remote control unit. Preferably, such adhesive means includes a release sheet, for convenience. In such an embodiment, the release sheet is removed and the article according to the invention is pressed into place on the outer portion of the remote control unit. According to a preferred form of the invention, an affixing band means has a length dimension of between 2.00 and 6.00 inches, including every hundredth inch therebetween, the exact length of which is dictated by the remote control unit to which the article of the invention is to be affixed. Thus, an affixing band means according to the invention may take on literally any length, but most practically, is any length up to about 10 inches.

The streamers according to the invention are long strips made from a material selected from the group of materials aforementioned as being suitable for constructing the affixing band means. Generally, the streamers (16 of FIG. 1) are rectangular strips of material, which are attached to the affixing band means so that the length dimension of the streamers is substantially perpendicular to the length dimension of the affixing band means. The streamers may be attached to the affixing band means by any conventional means known for attaching fabric or plastic materials to other substrates, including stitching, adhesives, rivets, thermal fusion, etc., with the only proviso being that the streamers must remain snugly attached to the affixing band means. In one preferred form of the invention, the streamers comprise plastic strips, such as PVC, vinyl, CPVC, polyolefin homopolymer, polyolefin copolymer, polypropylene, polyethylene, ethylene vinyl acetate, etc., and are attached to the affixing band by means of an adhesive, such as a hot-melt glue. In another preferred form of the invention, the streamers and the affixing band means comprise a woven fabric material, and are connected by stitching.

The streamers according to the invention are preferably at least 3 inches in length, more preferably at least 5 inches in length, more preferably still at least 7 inches in length, and in fact there is no limit to the length of the streamers; however, in one preferred form of the invention the streamers are less than 15 inches long, and most preferably between about 4.00 inches and 12.00 inches in length, including every hundredth inch therebetween.

The streamers are preferably made from a flexible material, which has a thickness between about 0.0005 inches and 0.1000 inches, including every 0.0001 inches therebetween.

The streamers are preferably colored so as to stand out against a background setting in which a unit according to the invention resides. Although all of the streamers may be of the same singular color, in a preferred form of the invention streamers comprising at least two different colors are employed. In yet another preferred form of the invention, streamers comprising at least three different colors are employed. While bright yellow streamers are especially preferred since they tend to stand out against most backgrounds, streamers comprising any color of the visible spectrum of light are suitable for employment within the context of the invention, including without limitation, red, yellow, pink, green, purple, orange, blue, indigo, violet, chartreuse, lavender, white, black, silver, and gold. Combinations representing the colors of professional sports teams are suitable for use according to the invention, as well as the combination of colors flown on the flags of various nations. Having streamers of different colors is especially beneficial in assisting persons with different forms of color-blindness to locate a remote unit.

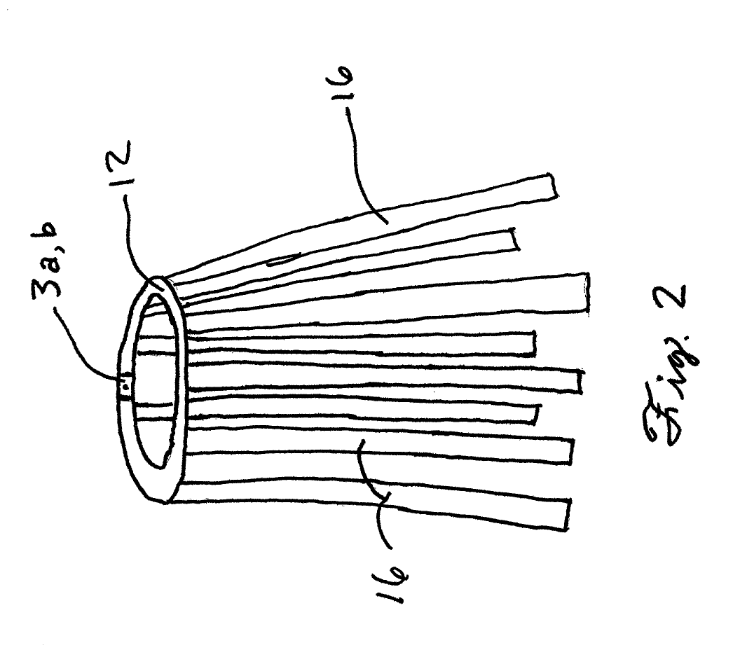

FIG. 2 shows an article according to the invention in which the affixing band means exists in the form of a closed loop, by virtue of the complementary counterparts 3a and 3b which collectively comprise the closure means having been cooperatively engaged with one another.

FIG. 3 shows an article according to the invention 10 disposed about the periphery of a remote control unit 22. According to the invention, a remote control unit so equipped is much more difficult to misplace, owing to the presence of the plurality of the streamers, which are multi-colored so as to stand out against any background situation in which the unit as a whole may reside.

According to one preferred form of the invention, the streamers or affixing band means, or both, may include writings, logos, etc. on their surfaces, to confer functionality as an advertising media to an article according to the invention.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

I claim:

1) An article useful for increasing the visibility of a remote control unit, which article comprises:
a) an affixing band means having a length dimension, and which is adapted to be snugly adhered to the outer periphery of a remote control unit;
b) a plurality of streamers, each having a length dimension, wherein said streamers are disposed along the length dimension of said affixing band so that the length dimension of said streamers is substantially perpendicular to the length dimension of said affixing band means.

2) An article according to claim 1 in which there is at least one streamer for every two inches of length dimension of said affixing band means.

3) An article according to claim 1 in which there is at least one streamer for every one inch of length dimension of said affixing band means.

4) An article according to claim 1 in which the length of at least one streamer is at least three inches in length.

5) An article according to claim 1 in which the color of each streamer of said plurality of streamers are identical to one another.

6) An article according to claim 5 in which the color of said plurality of streamers are selected from the group consisting of: black, white, yellow, pink, red or blue.

7) An article according to claim 1 in which the color of said streamers includes two or more colors.

8) An article according to claim 7 in which said plurality of streamers are of mixed color selected from the group consisting of: black, white, yellow, pink, red or blue.

9) An article as in claim 1 in which said affixing band means comprises an elastic fabric.

10) An article as in claim 1 in which said streamers comprise a material selected from the group consisting of polymeric materials and cloth fabrics.

11) An article as in claim 1 wherein the streamers have any thickness between about 0.0005 inches and 0.1000 inches, including every 0.0001 inches therebetween.

12) An article as in claim 1 wherein at least one of either of said streamers or said affixing band means includes writing on its surface.

13) An article useful for increasing the visibility of a remote control unit, which article comprises:
a) an affixing band means having a length dimension, a first end portion, a second end portion, a first face, and a second face, and which is adapted to be snugly adhered to the outer periphery of a remote control unit;
b) a plurality of streamers, each of said streamers having a length dimension, wherein said streamers are disposed along the length dimension of said affixing band so that the length dimension of said streamers is substantially perpendicular to the length dimension of said affixing band means;
c) a first closure means disposed in proximity to said first end portion of said affixing band means;
d) a second closure means disposed in proximity to said second end portion of said affixing band means;
wherein said first and second closure means are complimentary to one another to enable said affixing band means to form a closed loop.

14) An article according to claim 13 in which there is at least one streamer for every two inches of length dimension of said affixing band means.

15) An article according to claim 13 in which there is at least one streamer for every one inch of length dimension of said affixing band means.

16) An article according to claim 13 in which the length of at least one streamer is at least three inches in length.

17) An article according to claim 13 in which the color of each streamer of said plurality of streamers are identical to one another.

18) An article according to claim 17 in which the color of said plurality of streamers are selected from the group consisting of: black, white, yellow, pink, red or blue.

19) An article according to claim 13 in which the color of said streamers includes two or more colors.

20) An article according to claim 19 in which said plurality of streamers are of mixed color, comprising at least one color selected from the group consisting of: black, white, yellow, pink, red, green, orange, purple, or blue.

21) An article as in claim 13 in which said affixing band means comprises an elastic fabric.

22) An article as in claim 13 in which said streamers comprise a material selected from the group consisting of: polymeric materials and cloth fabrics.

23) An article according to claim 13 wherein said affixing band means comprises an adhesive substance on at least one of said first or second faces.

24) An article as in claim 13 wherein the streamers have any thickness between about 0.0005 inches and 0.1000 inches, including every 0.0001 inches therebetween.

25) An article as in claim 13 wherein at least one of either of said streamers or said affixing band means includes writing on its surface.
